(19) United States
(12) Patent Application Publication
(10) Pub. No.: US 2008/0050495 A1
(43) Pub. Date: Feb. 28, 2008

(54) PROCESS FOR MANUFACTURING AERATED FROZEN CONFECTIONS

(76) Inventors: Joselio Batista Vieira, York (GB); Myriam Schlegel, Fouquenies (FR); Hans-Juergen Erich Wille, St Martin le Noeud (FR)

Correspondence Address: WINSTON & STRAWN LLP;PATENT DEPARTMENT, 1700 K STREET, N.W., WASHINGTON, DC, 20006, US

(21) Appl. No.: 11/859,543

(22) Filed: Sep. 21, 2007

Related U.S. Application Data
(63) Continuation of application No. PCT/EP2006/002394, filed on Mar. 15, 2006.

(30) Foreign Application Priority Data
Mar. 21, 2005 (EP) EP 05102247.3

(51) Int. Cl. A23G 9/46; A23G 9/04; A23G 9/32

(52) U.S. Cl. 426/566

(57) ABSTRACT

A process for manufacturing aerated frozen confection incorporating a step of low temperature extrusion while preserving its smoothness and exhibiting reduced ice crystal growth after being exposed to heat shock is described, in which the frozen confection comprises fat, sweetener, milk solids-not-fat and water, and wherein an emulsifier is used comprising propylene glycol monoester of fatty acid.

### FIELD OF THE INVENTION

The present invention relates to the field of aerated frozen confections and particularly to a process for preparing such a confection.

### BACKGROUND OF THE INVENTION

Frozen confections, particularly milk-based frozen confections are traditionally made using ingredients such as: fat, milk solids-not-fat, sweeteners, stabilizers, emulsifiers and water. The various ingredients are mixed together, the mixture is then homogenized, pasteurized, cooled, optionally aged at about 2 to 6° C. and deep-frozen with stirring with injection of air in a freezer to provide a degree of overrun of the order of 30 to 150%.

Frozen confections are particularly appreciated for their creamy and smooth characteristics. However, these products, in order to preserve their optimum organoleptic characteristics of smoothness, have to be stored and handled with care. Thus, temperature variations, even small, can be observed during storage, distribution or handling. This is particularly the case when the consumer buys a frozen confection, when they do not consume it straight away and when there is a gap between the time the product is taken from the deep-frozen section and when it is placed in the domestic freezer. In such circumstances, substantial or partial thawing of the product may occur before it is refrozen. Such cycles of temperature variation, called heat-shocks are responsible for the growth of ice crystals in the product. A crystallized texture thus results therefrom. This texture and the icy mouth feel accompanied by an impaired appearance of the product compromises or at the very least reduce its overall quality as perceived by the consumer.

Various gums and/or emulsifiers have been used as additives with the aim of improving the stability, the smoothness and the resistance of frozen confections to heat shocks. These may include guar gum, carob or guar seed flour, alginate, carboxymethyl cellulose, xanthan, carrageenan, synthetic or natural emulsifiers. The milk proteins contained in the milk dry extract participate in this stabilization due to their water-binding property.

However, the use of gums has the disadvantage of conferring on the product a texture which is sometimes too firm or gummy.

Low temperature extrusion (LTE) technology has been developed to produce ice cream and frozen desserts a finer microstructure of air bubbles and ice crystal size which provides the final product with a superior smooth texture. Although the microstructure of the ice cream is kinetically stabilized by the low temperature processing, the dispersed ice crystals can still lower their free energy by forming fewer and larger crystals, which will eventually lead to an icy texture. Therefore LTE has the drawback that the ice crystals are not stabilized in case the products are subjected to heat shocks.

WO 01/06865 is concerned with a process for the production of aerated frozen confections which are smooth and have resistance to heat shocks, which makes use of propylene glycol monostearate (PGMS), unsaturated monoglyceride and sorbitan tristearate as emulsifiers and milk solids-not-fat coming predominantly from skim milk.

GB-A-1 484 167 is concerned with a method for making a partially frozen milk shake which comprises using cream, milk, glycerol as freezing point depressing agent, PGMS as emulsifier optionally together with glycerol monostearate and sodium stearoyl 2-lactylate, and carboxymethyl cellulose and carrageenan as stabilizers as well as other ingredients which are frozen in a conventional ice cream freezer to provide 50 to 100% overrun.

The problem that the invention proposes to solve consists in improving the heat shock stability of aerated frozen products produced by low temperature extrusion without compromising their organoleptic qualities.

### SUMMARY OF THE INVENTION

To this end, the present invention consists in a process for making aerated frozen confections comprising the following steps:
dispersion, heating and homogenisation of the ingredients entering into the composition of a frozen confection at a temperature, a pressure and for a period sufficient to hydrate and and pasteurize the mixture,
cooling of the mixture to a temperature of between 2 and 8° C.,
optionally aging of the mixture at a temperature of between 2 and 6° C., with or without stirring, during 4 to 24 h,
freezing to a temperature of between −4° C. and −10° C., with incorporation of gas providing a degree of overrun of between 30 and 150%,
further cooling the partially frozen aerated mixture in a screw extrusion down to temperature below −11° C. and
hardening of the mixture by deep-freezing to a temperature of between −20° C. and −40° C.

The invention further concerns a method of improving production, storage and distribution of aerated frozen confections extending over time, volume and space, by stabilizing ice crystal growth when it is exposed to heat shock, which comprises using propylene glycol monoester of fatty acid (PGME) as an emulsifier in an amount of at least 0.1% by weight.

The percentages indicated in the description relate to the percentages by weight except in the case of the overrun values which are defined in % by volume.

### DETAILED DESCRIPTION OF THE INVENTION

Preferably, a frozen confection according to the present invention may comprise 2 to 12% fat, 10 to 25% of sweeteners, 8 to 10% of milk solids-not-fat of which 80 to 100% are of whey origin, 0.1 to 0.5% of stabilizers, at least 0.1% of propylene glycol monoester of fatty acid as primary emulsifier and water as balance.

Thus the invention makes it possible to simultaneously improve the textural and organoleptic qualities of frozen confections, in particular after heat shock abuses.

The milk solids-not-fat used for making a frozen confection according to the invention may be powdered or concentrated defatted sweet whey, for example. They may include powdered or concentrated skim milk, for example. Milk solids-not-fat may also be derived from a commercial mixture of milk powder and whey proteins whose functionality has been modified by specific denaturation treatments.

Preferably, propylenglycol monoester of fatty acid (PGME) is used as a primary emulsifier in an amount of 0.1 to 0.25% by weight and most preferably in an amount of between 0.15 to 0.20% for getting the optimum smoothness. Preferably propylene glycol monostearate/palmitate is used.

The frozen confections prepared according to the invention may optionally comprise one additional emulsifier, for example, unsaturated monoglyceride or saturated mono-di glyceride in an amount of at least 5% of the total emulsifiers, preferably in an amount of 0.04 to 0.16% by weight as partial replacement of propylene glycol monoester of fatty acid.

The frozen confections prepared according to the present invention may comprise stabilizing agents; these may include carob flour, guar flour, alginates, carboxymethyl cellulose, xanthan, carrageenan, gelatin, starches used alone or in the form of a mixture at a dose of 0.1 to 0.5%, preferably about 0.25%.

The fat used may be a vegetable or animal fat, hydrogenated or otherwise fractionated, for example. It may be a fat of plant origin, preferably palm, coconut, soybean, rapeseed, olive, palm kernel oil, hydrogenated coconut oil, hydrogenated soybean oil, palm olein and their mixtures. It may also be a fat of animal origin, preferably butter fat and/or its fractions, which milk fat can be provided as cream.

The sweetener used may be sucrose, glucose, fructose or glucose syrup with DE (dextrose equivalent) varying from 20 to 42, or a mixture thereof, for example. The formulation of the product according to the invention may in addition comprise colourings such as beta-carotene, for example, and/or any type of flavourings or perfumes customarily used to flavour frozen confections, such as vanilla, strawberry or chocolate for example.

The compositions prepared according to the invention may optionally comprise additions such as fruit or fruit pieces, for example, or nuts, or hazelnuts, whole or in pieces, for example.

The choice of such ingredients makes it possible to obtain products with increased stability as well with a substantial reduction in the cost price. These savings are made through the partial replacement of the milk solids-not-fat traditionally used by whey. Furthermore, the organoleptic qualities of the frozen compositions prepared according to the invention are not reduced compared with the traditional products. Thus, the characteristics of smoothness and creaminess are increased and in particular, better preserved during the period of storage. In the frozen confections according to the invention, it is the use of propylene glycol monoester of fatty acid, as emulsifier which makes it possible to reduce remarkably the growth of water crystals in the products subjected to heat shock and thus it confers greater stability to heat shocks on the product.

For carrying out the process of the invention, the ingredients entering into the composition of a frozen confection prepared according to the present invention may be dispersed at around approximately 60 to 70° C. for approximately 15 to 30 min., for example. The whole may be heated and homogenized at around 70 to 75° C., for example, at a pressure of the order of 140 to 220 bar, for example. These steps of dispersion, heating and homogenisation make it possible to bring about hydration of the stabilizer.

The mixture may then be pasteurized according to methods known to persons skilled in the art, for example at around 80 to 90° C. for 10 to 30 s. The homogenisation-heating step may be carried out at a pasteurization temperature which brings about, on its own, pasteurization of the mixture.

The mixture may then be cooled to around 2 to 8° C. by known means. This mixture may then be aged or otherwise for 4 to 24 h at around 2 to 6° C., for example, with or without stirring. After this aging step, the mixture may be frozen at around −3 to −10° C., and preferably at about −4.5 to −8° C. with stirring with injection of gas so as to produce a degree of overrun of the order of 30 to 150%, for example. The mixture obtained may then be further cooled by extrusion at temperature below −11° C. in a refrigerated single or twin screw extruder and hardened by freezing at around −20 to −40° C., for example.

To evaluate the remarkable properties of the emulsifier applied, various textural, microscopic and macroscopic tests may be carried out.

Standard heat shock: the samples initially stored at −30° C. are subjected, for 7 days, to temperature cycles of −8° C./12h followed by −20° C./12h. After 7 days of stabilisation at −30° C., the melting parameters are evaluated for these samples which were subjected to a heat shock.

Size and Distribution of the Ice Crystals in an Ice Confection

An aliquot of ice confection is mixed with an equivalent quantity of glycerol and observed under a microscope at a temperature of −10° C. The measurement may be carried out in a chamber at −10° C. equipped with microscope and a camera. It is thus possible to measure the mean diameter Dm_{(1,0)} of the crystals (in μm) in the finished products and in the products which have been subjected to a heat shock (magnification 10×, respectively 20× depending on the crystals size).

The frozen confections prepared according to the present invention exhibit improved stability and organoleptic characteristics compared to traditional products. These products exhibit remarkable reduced ice crystal growth compared with traditional products when submitted to heat shock treatment. This property confers to the product smooth texture, which is considerably preserved after unfavourable storage conditions. Such functionalities make it possible to envisage production, storage and distribution of the products according to the invention extending over time.

A frozen confection prepared according to the present invention is therefore characterized in that it preserves its smooth texture and exhibits remarkable reduced growth of ice crystals due to ice recrystallization when submitted to heat shock conditions.

The expression “reduced crystal growth” is understood to mean an increase in the mean diameter Dm _{(1,0)} of the ice crystals of less than 50% after heat shock.

The invention is described below with reference to examples of preferred embodiments and modes of formulation. However, various adaptations and/or modifications may be made while remaining within the scope of the present invention.

### EXAMPLES

### Examples 1-4

### Improved Texture Stability of Low Temperature Extruded (LTE) Frozen Confection

From Table 1 below it can be noted that after 1 week heat shock the mean ice size of LTE product increases 211%. In comparison the regular processed product to same formulation, increases in mean ice size by 161%. This is to be expected, because with initially smaller ice crystals there is a much higher ice crystal surface area in the LTE product for potential liquefaction and re-deposition on the remaining (originally larger) crystals.

TABLE 1

| | Fresh product | Heat-shock product |
|---|---|---|
| | Median Dm_{(1,0)} | Median Dm_{(1,0)} |
| Conventional Freezing | 39 | 63 |
| Drawing temperature: −5° C. | | |
| LTE | 26 | 55 |
| Drawing temperature: −12.5° C. | | |

Propylene glycol monoesters of fatty acids (PGME) have been shown previously to work as inhibitor of ice crystal growth. The crystal growth inhibiting effect of PGME is not expected to be affected by process conditions. The two techniques described above, LTE and addition of PGME were therefore combined to control the ice crystal growth in frozen confections produced by LTE. Examples of aerated frozen confections made according to the present invention. Frozen confections were produced according to the formulations indicated in Table 2 below.

TABLE 2

| | Comp. | Example | Example | Example | Example |
|---|---|---|---|---|---|
| Ingredients/Trials | Example | 1 | 2 | 3 | 4 |
| Milk Cream 35% Fat | 10.00 | 10.00 | 10.00 | 10.00 | 10.00 |
| Casein/Whey Protein | 10.50 | 10.50 | 10.50 | 10.50 | 10.50 |
| Blend 20% | | | | | |
| Cremodan 809 Creamline | 0.50 | — | — | — | — |
| PGMS | — | 0.10 | 0.15 | 0.20 | 0.25 |
| SMDG | — | 0.08 | 0.08 | 0.08 | 0.08 |
| Guar Gum | — | 0.15 | 0.15 | 0.15 | 0.15 |
| Locust Bean Gum | 0.10 | 0.15 | 0.15 | 0.15 | 0.15 |
| Invert glucose syrup DE | 17.30 | 17.30 | 17.30 | 17.30 | 17.30 |
| 40 | | | | | |
| Glucose syrup DE 36-40 | 4.30 | 4.30 | 4.30 | 4.30 | 4.30 |
| Water | 57.30 | 57.30 | 57.30 | 57.30 | 57.30 |

Casein/whey protein blend: Nollibel LV154, Bel Industries
PGMS: Propylene glycol monostearate PGMS SPV ® from Danisco;
SMDG: Saturated Mono-diglycerides: ADMUL ® 60-04 from Kerry.

A combination of a traditional ice cream freezer and a twin screw low-temperature extruder was used for the frozen confection production. The conventional freezer (APV WCB) was used as the first cooling step and operated in a serial configuration with the low-temperature extruder (Schröder, Lubeck, Germany). The inlet temperature of the mixture in the freezer was +4° C., the exit temperature on the freezer was −5.0° C. and the exit temperature −15° C. on the extruder. The extruder was set to 14 rpm and overrun to 100% at a mix flow rate of 50 L/h.

Table 3 shows that like in conventional freezing, as the concentration of PGMS increases in the frozen confection, the ice crystal size reduces in LTE-produced frozen confection.

TABLE 3

| | Fresh product | Heat-shock product |
|---|---|---|
| Recipe | Median Dm_{(1,0)} | Median Dm_{(1,0)} |
| Example 4 (0.25% PGMS) | 28 | 28 |
| Example 3 (0.20% PGMS) | 32 | 36 |
| Example 2 (0.15% PGMS) | 35 | 47 |
| Example 1 (0.10% PGMS) | 41 | 54 |
| Recipe Comp Ex (No PGMS) | 37 | 80 |

Sensory Analysis:

The samples are evaluated by a panel of people trained in the evaluation of texture. To that end, samples of examples of the invention are compared with the same after having been subjected to heat shock. The questionnaire distributed contains the descriptive attributes for smoothness, absence of large ice crystals in the frozen confection mass. The samples were thus evaluated by trained panellists who score each texture attribute in a scale from 0 to 100. The results arc given in Table 4 below.

TABLE 4
Table 4. Smoothness scores given by a panel of trained panel. 0
means low smoothness and 100 high smoothness.

| | Fresh product | Heat-shock product |
|---|---|---|
| Recipe | Smoothness | Smoothness |
| Example 3 (0.20% PGMS) | 76 | 51 |
| Example 2 (0.15% PGMS) | 83 | 64 |
| Example 1 (0.10% PGMS) | 83 | 47 |
| Recipe Comp Ex (No PGMS) | 70 | 32 |

We were surprised to find that the product smoothness does not progressively improve with the ice crystal size reduction. The table above show that the smoothness reduces significantly when PGMS concentration is increased above 0.15%. We believe that the relative loss of smoothness when the PGMS concentration exceeds 0.15% is due to high level of fat destabilization which produces a coarse texture.

What is claimed is:

1. A process for preparing an aerated frozen confection, with or without fat and comprising a sweetener, milk solids-not-fat, water, emulsifier and stabilizer as ingredients, which comprises by weight 0 to 12% fat, 4 to 10% milk solids-not-fat, 10 to 25% sweeteners, 0 to 0.5% stabilizers, at least 0.1% of a propylene glycol monoester of fatty acid as primary emulsifier and which has an overrun of 30 to 150% by volume, the process comprising:
dispersing, heating and homogenizing of the ingredients entering into the composition of a frozen confection at a temperature, a pressure and for a period sufficient to form a mixture and to hydrate and pasteurize the mixture,
providing the mixture with an overrun between 30 and 150%, and
cooling the mixture to a temperature below −11° C. while agitating the mixture to provide a low temperature frozen aerated confection.

2. The process of claim 1, wherein the cooling comprises:
a first cooling of the pasteurized mixture prior to the creation of the overrun to a temperature below −3° C., and
a second agitated cooling following the creation of the overrun to a temperature below −11° C.

3. The process of claim 1, wherein the cooling while agitating the mixture is to
a temperature between −12° C. and −18° C.

4. The process of claim 1, wherein the cooling and agitating of the mixture is achieved in a screw extruder.

5. The process of claim 1, wherein the cooling and agitating of the mixture is achieved in a scrape surface heat exchanger.

6. The process of claim 1, wherein the frozen aerated mixture is hardened by static deep-freezing to a temperature between −20° C. to −40° C.

7. The process of claim 1, wherein the frozen confection comprises 2 to 12% fat by weight

8. The process of claim 1, wherein the milk solids-not-fat in the frozen confection comprises powdered or concentrated skim milk and/or mixtures with whey proteins.

9. The process of claim 1, wherein the aerated frozen confection comprises at least one stabilizer chosen from the group comprising carob flour, guar flour, an alginate, carboxymethyl cellulose, xanthan, carrageenan, gelatin, a starch used alone or in the form of a mixture at a dose of 0.1 to 0.5% by weight.

10. The process of claim 1, wherein the sweeteners in the aerated frozen confection are chosen from the group consisting of sucrose, glucose, fructose or glucose syrups and mixtures thereof.

11. A process for preparing an aerated frozen confection, with or without fat and comprising a sweetener, milk solids-not-fat, water, emulsifier and stabilizer as ingredients, which comprises by weight 0 to 12% fat, 4 to 10% milk solids-not-fat, 10 to 25% sweeteners, 0 to 0.5% stabilizers, at least 0.1% of a propylene glycol monoester of fatty acid as primary emulsifier and which has an overrun of 30 to 150% by volume, the process comprising:
dispersing, heating and homogenizing of the ingredients entering into the composition of a frozen confection at a temperature, a pressure and for a period sufficient to form a mixture and to hydrate and pasteurize the mixture,
cooling of the mixture to a temperature of between 2 and 8° C.,
optionally aging of the mixture at a temperature of between 2 and 6° C., without stirring, during 4 to 24 h,
freezing to a temperature of between −4° C. and −10° C., providing a degree of overrun of between 30 and 150%,
further cooling the aerated mixture by extrusion to a temperature below −11° C. in a screw extruded, and
hardening of the mixture by deep-freezing to a temperature of between −20° C. and −40° C.

12. A method for improving production, storage and distribution of aerated low temperature frozen confections extending over time, volume and space, by stabilizing ice crystal growth when it is exposed to heat shock, which comprises incorporating in the confection prior to freezing a propylene glycol monoester of fatty acid as an emulsifier in an amount of from 0.1 to 0.5% by weight.

13. The method of claim 12, wherein the propylene glycol monoester of fatty acid is present in an amount of 0.1 to 0.3% by weight.

14. The method of claim 12, wherein the propylene glycol monoester of fatty acid is propylene glycol monostearate/palmitate.

15. The method of claim 12, which further comprises incorporating as additional emulsifier a saturated mono-di glyceride in an amount of at least 5% by weight of all emulsifiers and in partial replacement of propylene glycol monoester of fatty acid.

16. The method of claim 12, which further comprises incorporating as additional emulsifier a saturated mono-di glyceride in an amount of 0.04 to 0.16% by weight.

17. An aerated frozen confection obtained by low temperature freezing or extrusion in a manner to preserve its smoothness and which exhibits reduced ice crystal growth after being exposed to heat shock conditions which comprises a propylene glycol monoester of fatty acid incorporated in the confection prior to freezing as an emulsifier in an amount of 0.1 to 0.5% by weight.
